(19) United States
(12) Patent Application Publication
(10) Pub. No.: US 2014/0180184 A1
(43) Pub. Date: Jun. 26, 2014

(54) NEUROPLASTICITY VERTIGO TREATMENT DEVICE AND METHOD

(71) Applicant: James Duguid, Indianapolis, IN (US)

(72) Inventor: James Duguid, Indianapolis, IN (US)

(21) Appl. No.: 14/026,590

(22) Filed: Sep. 13, 2013

Related U.S. Application Data
(60) Provisional application No. 61/701,302, filed on Sep. 14, 2012.

(51) Int. Cl. A61H 1/00

(52) U.S. Cl. CPC A61H 1/001
USPC 601/87

(57) ABSTRACT

A neuroplasticity vertigo treatment device for subjects who suffer from a balance disorder that limits the ability to stand or walk without holding onto an external support. The device is characterized by a wearable body prosthesis or harness with gyroscopic stabilization that either selectively locks or produces a torque in the same axis but opposite to the direction of an imbalanced movement by a subject wearing the device.

### BACKGROUND

The present disclosure describes a gyroscope balance-assist device which improves the balance of individuals suffering from a variety of balance disorders (e.g., vertigo) or of those who seek enhanced balance for recreational or occupational activities such as sports, dancing, etc. Additionally, the device could be used by animal subjects. The balance-assist device provides both immediate benefits to a subject as well as benefits after a regimen of use. The device may be suitable for both limited, clinic-only settings as well as everyday personal use.

U.S. Patent Publication 20020010497 claims to aid individuals suffering from balance or vestibular disorders. Additionally, the '497 patent publication claims to be designed for use by animals as well as individuals who do not suffer from a balance or vestibular disorder for “enhanced sensory function.” U.S. Patent Publication 20020010497 describes a balance prosthesis small enough to be worn about the body in the course of daily activities. It includes a motion sensing system, a signal processor, an encoder, and a stimulator. The motion sensing system generates a signal that indicates a specific body motion, such as a fall, and sends this to the processor and encoder. Based on this signal, the stimulator may be activated to inform the wearer that a certain body motion is occurring. Several passive methods of stimulation for the device are described. These include vibrating tactors and implanted electrodes. Additionally, the '497 patent publication clarifies that “other stimulators can be substituted or used in addition to those described above.” These include stimulators that provide acoustic and visual signals.

U.S. Patent Publication 20070038268 claims to improve postural stability, specifically in individuals suffering from malfunctions of the inner ear or in the part of nervous system responsible for processing motion “due to injury, disease, or to prolonged exposure to altered gravity.” U.S. Patent Publication 20070038268 is essentially a more developed version of U.S. Patent Publication 20020010497 published five years earlier. It consists of the same core components and performs the same basic function. It specifies several possible methods for its stimulation. These include using vibrating tactors against the body in column formations, auditory and visual stimulation, and using electric stimulation of the skin and tongue.

U.S. Patent Publications 20070038268 and 20020010497 are both essentially passive devices and because of this face several drawbacks. While they send a stimulating feedback signal informing the wearer of an impending fall and the direction of that fall, it is left up to the wearer to make the necessary bodily adjustments to remain balanced. In many cases, a subject may not be physically able to make these bodily adjustments, or may not able to make them quickly enough. Additionally, a subject with severe spatial disorientation might not be able to determine what bodily adjustments are necessary in the first place.

While the devices disclosed in U.S. Patent Publications 20070038268 and 20020010497 serve a related purpose—balance aid—the device described here in the present disclosure is inherently different than that described in these publications and provides a fundamentally distinct and potentially superior function while at the same time eliminating the drawbacks they face. The device of the present disclosure uses an actuation method that provides a physical, corrective or resistive force in the form of the counteracting torque of the gyroscope(s). Theoretically, even a completely immobile subject would experience a balance-improving effect when wearing the device due to the physical, corrective torque provided by the gyroscope (s). Additionally, a subject also experiences passive, haptic stimulation from feeling the torque and pull of the gyroscope (s). This type of haptic signal from the gyroscope (s) may provide a superior and more effective form of passive feedback stimulation than the methods described in U.S. Patent Publications 20020010497 and 20070038268. Thus, there is a need for improvement in this field.

### SUMMARY

A patient who suffered from a balance disorder that prevented her from standing without holding onto an external support was able to stand independently when she held a small mechanical gyroscope in a fixed position with its flywheel spinning on an axis perpendicular to the ground. Similar results were thereafter experienced with several other individuals. It is believed that this gyroscopic stabilization phenomenon was the result of both the corrective, physical force of the gyroscope as well as the supplementary haptic feedback it provided. It is an objective of the present disclosure that this effect may be recreated, focused, and amplified using a wearable device intended to improve an individual's ability to balance. This may be most beneficially achieved with the use of a modified gyroscope, known as a control moment gyroscope (CMG). A CMG is an attitude control device that has recently found practical use in spacecraft attitude control systems such as for controlling satellite orientation in outer space. A CMG consists of a spinning rotor and one or more motorized gimbals that tilt the rotor's angular momentum. As the rotor tilts, the changing angular momentum causes a gyroscopic torque that rotates the target body. A CMG uses gyroscopic forces to produce rotational torque in one or two axes. When fixed to a target object, a CMG's torque will be transferred and the object will experience rotational forces. In the present disclosure, the rotational torque produced by one or more relatively small CMGs is controlled and integrated into a user wearable device so as to provide a similar but enhanced set of benefits as the simple, mechanical gyroscope for human subjects struggling with balance.

According to one embodiment of the disclosure, a neuroplasticity treatment device is provided comprising a wearable body prosthesis, at least one control moment gyroscopic attached to the prosthesis that produces a torque in the same axis but opposite to the direction of an imbalanced movement by a subject wearing the device. The device may include a wearable body prosthesis, such as a harness or belt that surrounds at least a portion of the torso of the wearer. The wearable body prosthesis may include at least one vertical mounting rail which allows the vertical position of the at least one control moment gyroscope to be adjusted with respect to the subject. The control moment gyroscope may be attached to the prosthesis at a position which maximizes the torque relative to the center of balance of the subject. The prosthesis may be a belt surrounding at least a portion of the waist and hips of the wearer, but may include additional straps. The device may comprise a plurality of CMGs spaced apart around and mounted upon the belt, with the belt comprising a waist belt wearable garment.

According to another embodiment of the disclosure, a device is provided, comprising a wearable body harness and a gyroscope mounted to the harness. The gyroscope comprises a rotor assembly, a first gimbal surrounding and operatively connected to the rotor assembly, and a second gimbal surrounding and operatively connected to the first gimbal and the wearable body harness. The rotor assembly may comprise a motor having a central shaft and a housing, said housing being rotatable about the central shaft, the central shaft having first and second ends fixedly connected to the first gimbal, an annular rotor fixedly connected to the motor housing and rotatable about the central shaft with the motor housing, and a plurality of energy storage devices mounted to the motor housing symmetrically about the central shaft and rotatable about the central shaft with the motor housing. The device may further comprise a first clutch connected between the first gimbal and the second gimbal, the first clutch operable to selectively lock the position of the first gimbal relative to the second gimbal, and a controller operatively connected to the first clutch, said controller operable to operate the first clutch in a locked or free state. The device may further comprise a second clutch connected between said second gimbal and said wearable harness, said controller operable to operate the second clutch in locked or free spinning state. The device may further comprise at least one balance sensor operably connected to said controller. The controller may be configured to determine an imbalanced movement by a subject wearing the device and lock at least one of said first and second clutches in response to the imbalanced movement. The device may further comprise an upper mounting plate fixedly connected to said motor housing, and a lower mounting plate fixedly connected to said motor housing, wherein said upper and lower mounting plates are located on opposite sides of said annular rotor. The rotor may comprise a plurality of openings located symmetrically about said central shaft, wherein said plurality of energy storage devices pass through respective ones of said openings, the energy storage devices further mounted between said upper and lower mounting plates.

Further forms, objects, features, aspects, benefits, advantages, and embodiments of the present invention will become apparent from a detailed description and drawings provided herewith.

### BRIEF DESCRIPTION OF THE DRAWINGS

FIGS. 1a-c, respectively, shows a human body wearing a device according to one embodiment of the present disclosure and alternate layouts of the device including its core components.

FIGS. 2a and 2b, respectively depict an illustration of a human body's sagittal and coronal axes and how they relate to body motion.

FIGS. 3a and 3b are diagrams illustrating the force of the torque produced against the direction of a fall of a body using the device of the present disclosure.

FIG. 4 illustrates a perspective view of a device according to a further embodiment of the present disclosure.

FIG. 5 illustrates a top view of the device of FIG. 4.

FIG. 6 illustrates a side view of the device of FIG. 4.

FIG. 7 illustrates a perspective view of a rotor assembly of the device of FIG. 4.

FIG. 8 illustrates a side view of the rotor assembly of FIG. 7.

FIG. 9 illustrates a top view of the rotor assembly of FIG. 7.

FIG. 10 illustrates a bottom view of the device of FIG. 7.

FIG. 11 illustrates a human subject wearing the device of FIG. 4.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

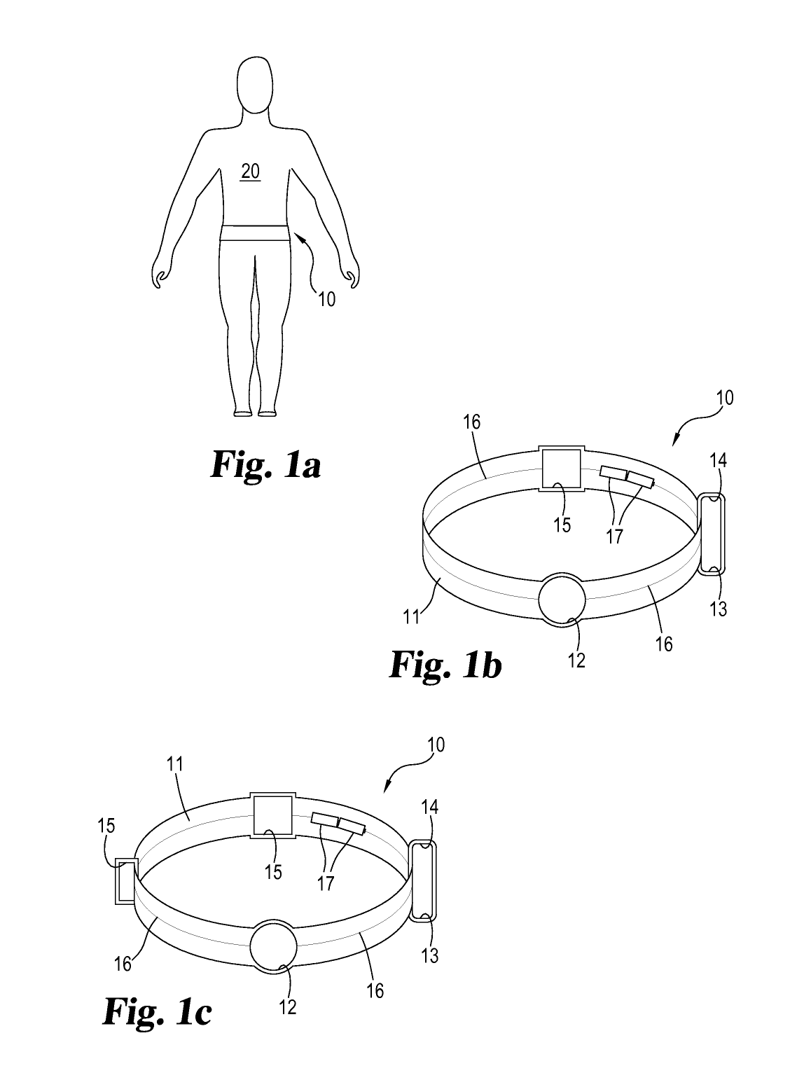

The basic core components of the device 10 generally include a wearable body prosthesis, such as a belt or harness 11 with an attached, integrated sensing system 12, processing system 13 which may for example include a standard computer microprocessor 14 having associated computer processing circuitry components, one or more gyroscopes 15, which may be optionally implemented as control moment gyroscopes (CMGs), and connective wires 16. The device 10 may also include one or more rechargeable batteries 17 for providing the necessary electric power requirements. A layout of the device 10 and its core components can be seen in FIG. 1. The device 10 relies on the interworking of these components for operation.

There are many possible ways to configure the basic elements of the device 10. For example, the sensing system 12 may consist of one or more linear and/or angular motion sensors such as small micro-mechanical accelerometers or gyroscopes that measure motion in one or more axes. Other types of sensors known in the art may also be used including, but not limited to, mechanical tilt sensors, distance sensors, laser sensors, and the like). These can be attached in multiple locations on the belt or harness 11 so they can best sense a subject's orientation and state of balance. Additionally, the sensors may be placed on additional parts of the body apart from the harness or belt 11 but still connected to the processor 14 with connective wires 16 or by wireless mediums. The processor 14 can be mounted on the belt or harness 11 in various locations, and is pre-programmed with computer readable instructions appropriate to the particular arrangement. One or more gyroscopes 15 can be attached to the belt or harness 11 in multiple locations that maximize the effectiveness of the torque produced. Either single or dual-gimbal CMGs may be used, as well as fixed or variable speed CMGs. In other embodiments, the gyroscopes 15 may operate as selectively locked or free-floating, as will be described further below. One example of a CMG design such as would be suitable for this purpose is described in detail in U.S. Pat. No. 7,997,157 issued to Smith, et al., which disclosure is hereby expressly incorporated herein. Another CMG of a type suitable for use in the device of the present disclosure is a model produced by Honeybee Robotics of New York, N.Y. named “Tiny Operationally Responsive CMG (TORC),” which can be seen on their website at http://www.honeybeerobotics.com/product-examples/aeromechanical/12-cmg. The belt or harness 11 may constitute a wearable body prosthesis that surrounds at least a portion of the torso of the wearer. In one preferred embodiment, the wearable body prosthesis is a belt 11 that surrounds the waist and hips of the wearer.

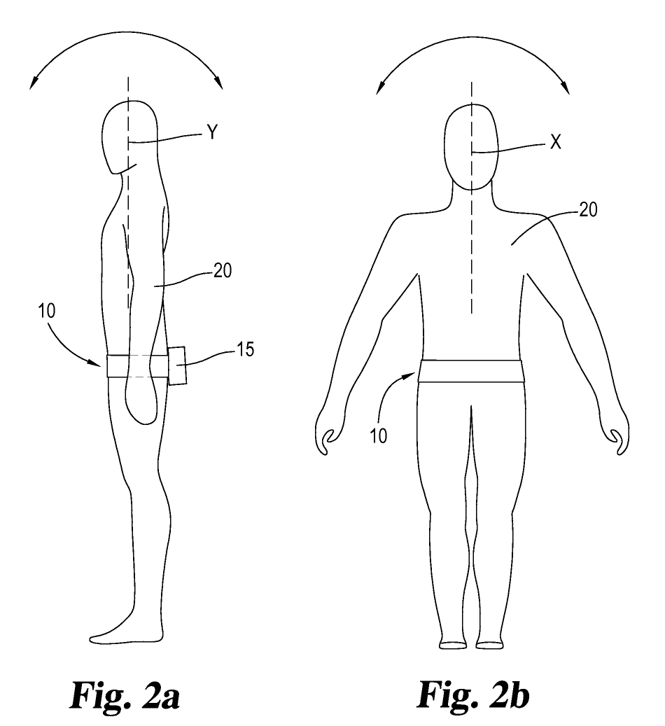

When a standing subject 20 wears the device 10, the sensing system 12 retrieves information that reflects the subject's body orientation and motion in both the sagittal and coronal axes. An illustration of these axes and how they relate to body motion can be seen in FIGS. 2a and 2b. Motion in the sagittal plane “X” (FIG. 2b) indicates a fall or imbalance to either the back or front, and motion in the coronal plane “Y” (FIG. 2a) indicates a fall or imbalance to either the left or right. This data is then sent through connective wires 16 or via a wireless medium to processor 14. The processor 14 is programmed to read this data and interpret whether the subject 20 is unbalanced, and if so in what axis, what direction, and how severely. If the processor 14 interprets that the subject 20 is falling in a certain direction, it sends signals through connective wires 16 to activate one or more CMGs 15. When activated, the CMG(s) produces a torque in the same axis but opposite direction of the fall. This results in a force that counteracts the motion of the potential fall.

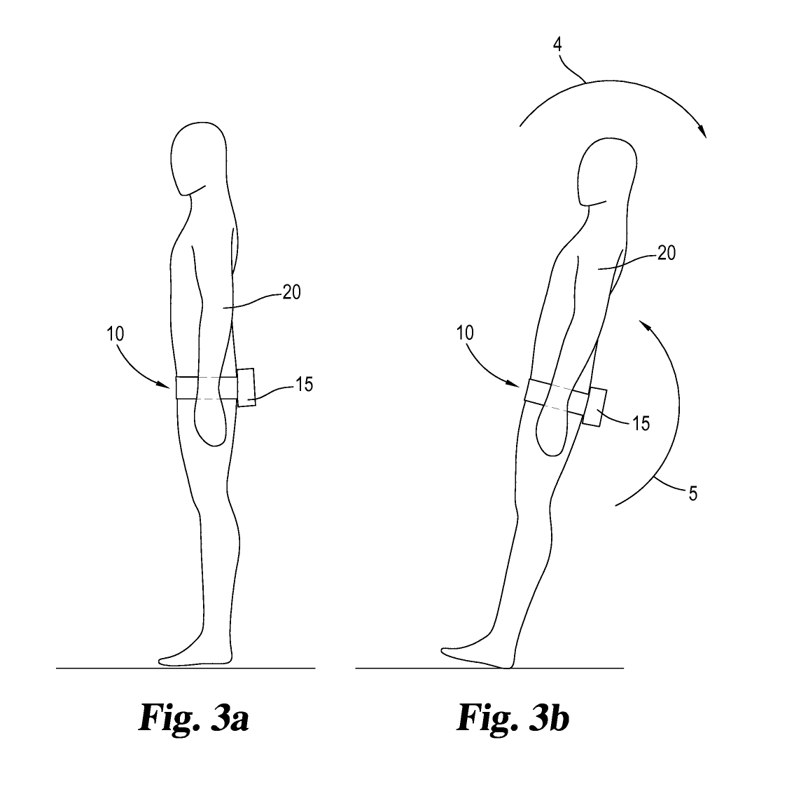

A diagram illustrating the force of this torque produced against the direction of a fall can be seen in FIGS. 3a and 3b. FIG. 3a depicts a standing, balanced subject 20 wearing the device 10. On the right, the FIG. 3b depicts a standing subject 20 experiencing a backwards fall. The subject 20 is wearing the device 10 around the subject's waist and/or hips. The direction 4 of the rotational force of the subject's fall is shown along with the direction 5 of the correctional torque produced by the one or more CMG(s) 15 mounted on the belt or harness of the device 10. If the fall or imbalance occurs in both the sagittal and coronal axes, multiple CMGs 15 may be activated. Additionally, the amount of torque produced by the CMG(s) 15 may be variable based on the severity of the fall or imbalance.

The counteractive torque of the one or more CMGs 15 improves the subject's balance through two primary mechanisms. One way this torque improves a subject's balance is by providing a physical, corrective force that acts directly on the body, maintaining and supporting a subject's balanced, upright position. For example, if a person begins to fall backwards the torque of a CMG 15 can be directed to physically “rotate” a subject's body back into balance. The device 10 could provide torque to correct potential falls in multiple directions; additionally, the amount of torque provided could be proportional to the severity of the potential fall.

A second way this correctional torque improves a subject's balance is by providing supplementary sensory feedback, which improves a subject's general awareness of body position and balance. When determining and maintaining balance, a healthy individual integrates feedback from multiple sensory systems including the visual and vestibular systems. When one or more of these systems has been impaired in some way a subject no longer receives the necessary amount of sensory input with which to accurately determine balance, resulting in a balance disorder. However, when physically experiencing the corrective pull and torque of a CMG, a subject is provided with a source of additional, external sensory input in the form of haptic feedback. The subject can use this haptic feedback to better approximate general body orientation and proprioception, ultimately improving the subject's ability to adapt body position to maintain balance.

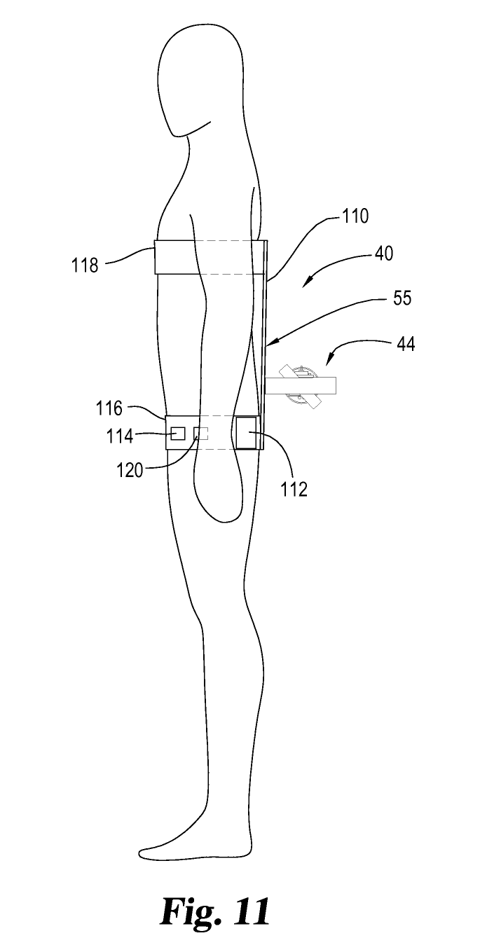

FIG. 11 depicts a neuroplasticity balance device 40 according to a further embodiment. The device 40 includes a gyroscope 44 mounted to a wearable body prosthesis, such as harness 55. The harness 55 includes one or more vertical rails 110. The rails 110 are attached to a lower harness portion, such as a belt 116 and an upper harness portion, such as strap 118. The vertical location of the gyroscope 44 relative to the wearer can therefore be adjusted by mounting the gyroscope 44 at a desired location along the vertical rails 110. In a preferred embodiment, the gyroscope 44 is positioned near the second sacral vertebrae, which is typically near a human subject's center of balance. However, the position of the gyroscope 44 may be adjusted depending on a variety of factors including, but not limited to, the anatomy of the wearer or other considerations made by a physician or therapist. Such factors may also be used to determine the placement of the harness 55 on the wearer, in addition to the placement of the gyroscope 44 on the harness 55. It shall be understood that the harness 55 may be implemented in various forms, such as a simple belt (similar to harness 11) or as a multi-point harness having upper and lower torso attachment straps. The harness 55 may also comprise a thermoplastic molded unit which has been formed fitted to the wearer.

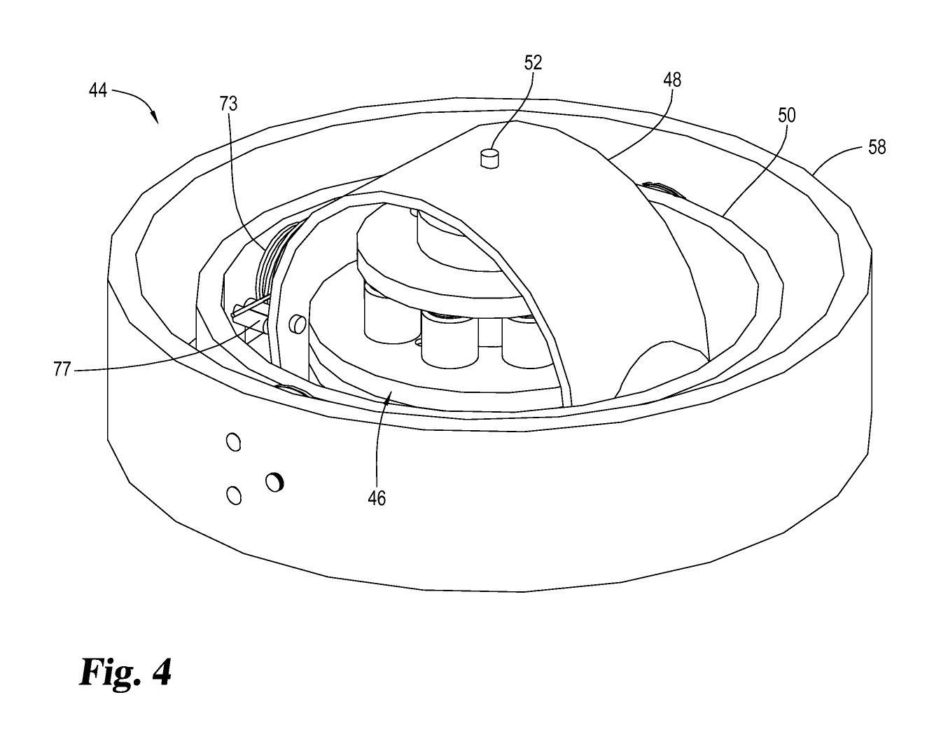

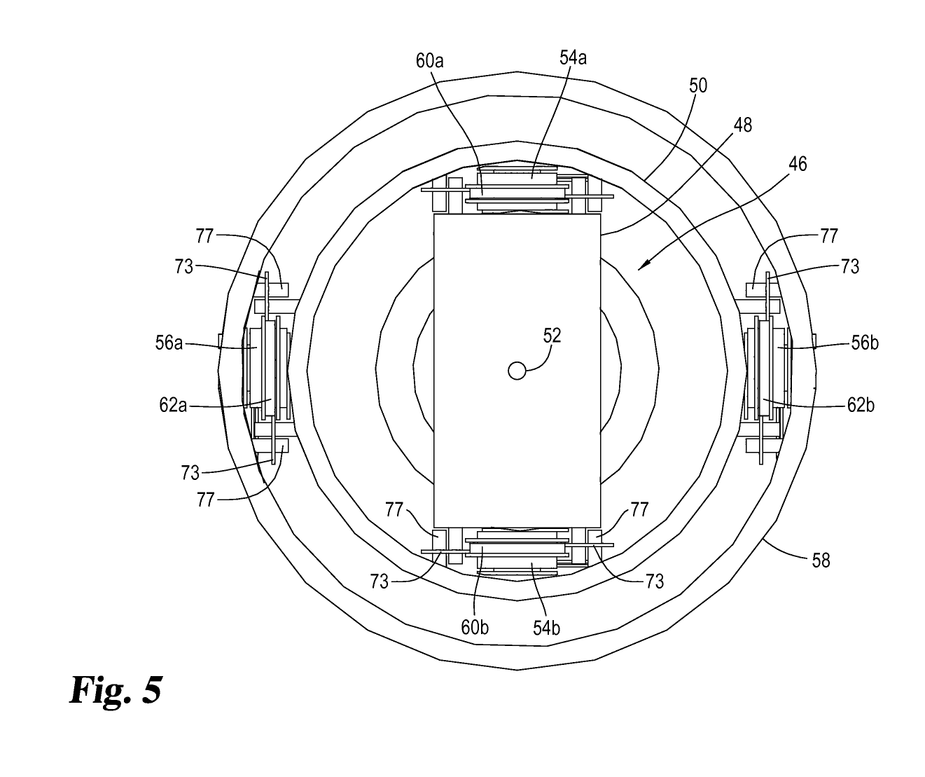

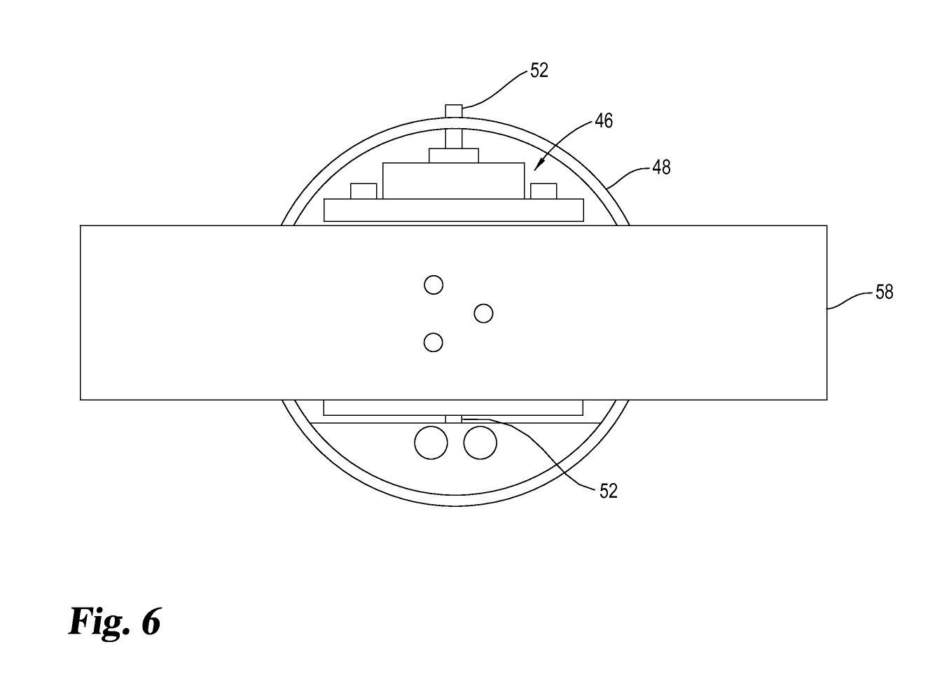

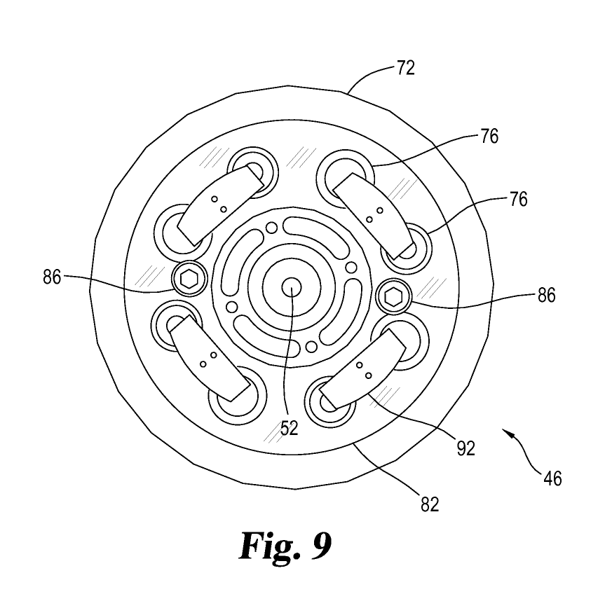

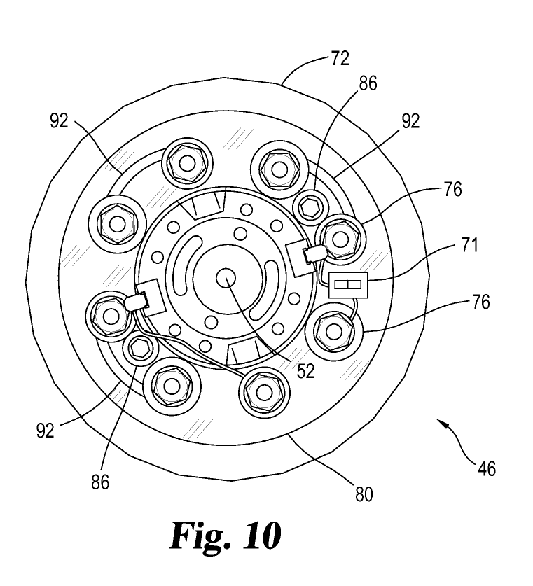

As shown in FIGS. 4-10, the gyroscope 44 includes a rotor assembly 46, an inner gimbal 48 and an outer gimbal 50. The rotor assembly 46 is connected to the inner gimbal 48 by a central shaft 52 as shown. The inner gimbal 48 is rotatably connected to the outer gimbal 50 by bearings 54a and 54b. The outer gimbal 50 is rotatably connected to an outer frame 58, shown here in annular form, via bearings 56a and 56b. Due to the relative position of the bearings 54 and 56, rotational movement of the inner gimbal is oriented to be perpendicular to that of the outer gimbal.

Clutches 60a and 60b may also be optionally connected between the inner gimbal 48 and outer gimbal 50 as shown to selectively lock the position of the inner gimbal with respect to the outer gimbal 50 and/or the frame 58. Clutches 62a and 62b may also be optionally connected between the outer gimbal 50 and the frame 58 as shown to selectively lock the position of the outer gimbal with respect to the frame 58. The frame 58 is connected to the wearable harness 55 as shown in FIG. 11, and may be optionally adjustable (e.g., vertically or horizontally) within the harness.

Rotational springs 73 and stops 77 may optionally provided at the rotational attachment points between the inner and outer gimbals, and the outer gimbal and the frame 58. The springs 73 and stops 77 work in concert to prevent the gimbal from wandering unnecessarily and help to further to steady the gyroscope 44.

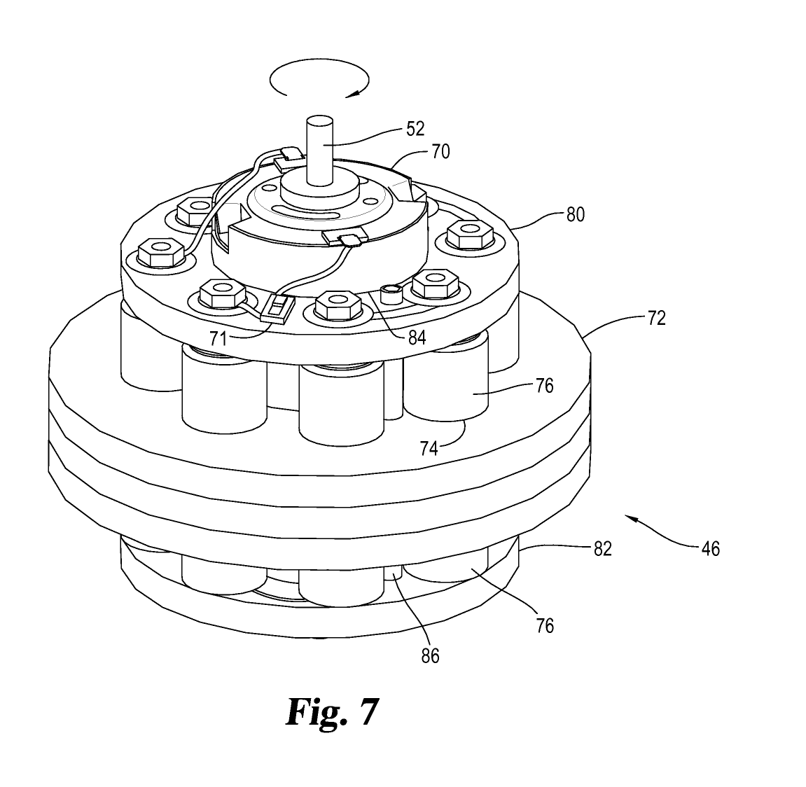

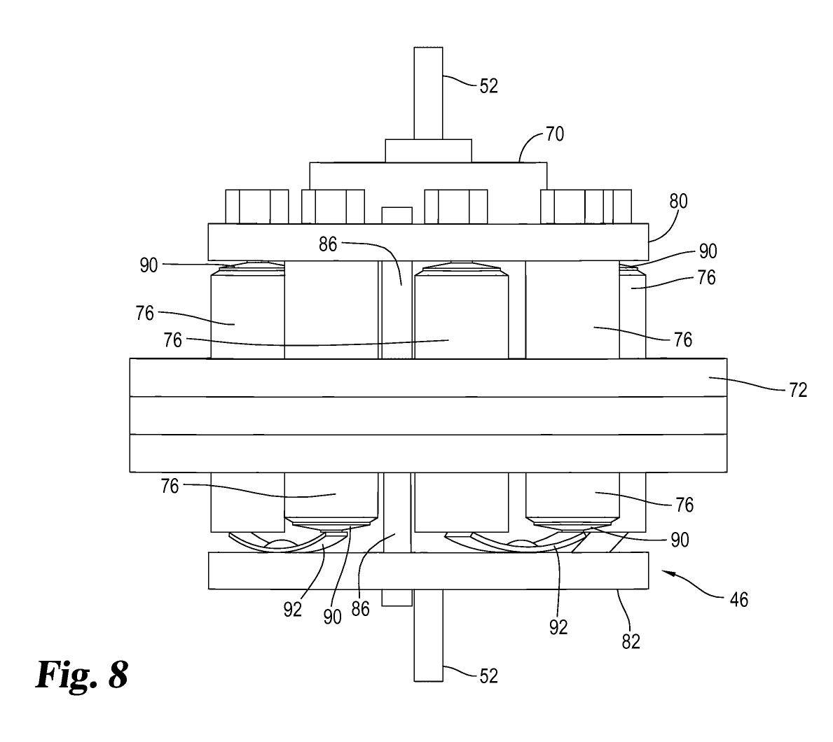

As shown in further detail in FIGS. 7 and 8, the rotor assembly 46 comprises a motor 70 and an annular rotor 72 disposed about the central shaft 52. As used herein, the term “rotor” shall be interpreted to mean an inertial mass rotatably mounted to a central shaft. As used herein, the term “rotor assembly” shall be interpreted to mean the combination of the motor 70, rotor 72, and shaft 52. A plurality of energy storage devices 76 may be optionally included and electrically connected, either serially or in parallel, to the motor 70 via a switch 71 for powering the motor 70. The energy storage devices 76 may comprise batteries, capacitors, or any other energy storage system known in the art. In the illustrated embodiment, the energy storage devices are implemented as size AA cylindrical batteries having connection terminals 90. The energy storage devices 76 are arranged in a symmetrical pattern about the central shaft 52 in order to maintain proper balance of the rotor assembly as it spins about the central shaft 52 during operation. Also, by locating the energy storage devices about the same central axis as the motor 70, a more compact overall design is achieved. Furthermore, the positions of the various components of rotor assembly 46 along the shaft 52 are selected so as to ensure that the center of gravity of the rotor assembly is at the center of the inner gimbal to prevent translational acceleration from affecting the attitude of the gyroscope 44.

In the illustrated embodiment, the energy storage devices 76 are slidably disposed through holes 74 in the rotor 72 and further held in position by end plates 76 and 78. The end plates 80 and 82 may be held in position by a variety of methods. For example, the central aperture 84 of each end plate 80 and 82 may be sized to press fit onto the housing of the motor 70. Alternatively, rods or bolts 86 may be provided which secure the end plates 80 and 82 to the rotor 72 and thereby maintain a suitable pressure between the end terminals 90 of the energy storage devices 76 and electrical jumpers 92.

The rotor 72 may be constructed of any suitable material known in the art, although in a preferred embodiment the rotor 72 is composed of metal (e.g., aluminum, steel, or the like) to provide sufficient intertial mass for generating the gyroscopic force and/or torque required during operation. The rotor 72 may further comprise a plurality of annular elements held together in a sandwich arrangement.

The motor 70 may be implemented in a variety of forms. For example, the motor 70 may comprise a 12 volt DC electric motor. When electrically connected to the energy storage devices 72 via switch 71, the motor 70 will cause the rotor assembly 46 to spin about the central shaft 52, which is fixed to the inner gimbal 48.

The switch 71 may be implanted as a manually operated electromechanical switch, or as a remotely operated switch. For example, an external wireless transmitter may be provided within the body harness. The switch 71 will receive command signals from the transmitter, and connect or disconnect the energy storage devices 76 from the motor 70 as desired.

The device 40 may also include a processing system 112, similar to processing system 13 and/or processor 14 discussed above. The processing system 112 is operatively connected to the clutches 60 and 62 of gyroscope 44. The device 40 may also include a sensing system 114, which is similar to sensing system 12 discussed above. The sensing system 114 is operatively connected to the processing system 112. The sensing system 114 senses the movements of the wearer, similar to sensing system 12 discussed above. The device 40 may also include additional batteries or energy storage devices mounted within the harness 55 for powering the processing system 112 and/or sensing system 114.

The device 40 operates as follows. When an imbalanced movement is sensed by the processing system 112 and/or sensing system 114, the processing system 112 causes the clutches 60 and 62 to lock. With the clutches locked, the gyroscope 44 will tend to limit further imbalanced movement and also alert the wearer that they are starting to lean or fall. In one embodiment, the clutches will remain locked until the processing system 112 detects that the wearer has regained a balanced position or gait. In other embodiments, the clutches may remain locked for a specific time, and then return to free-spinning operation.

In still further embodiments, the clutches 60 and/or 62 may be replaced with motors which selectively adjust or actuate the rotation of the inner and outer gimbals with respect to the frame 58, essentially allowing the gyroscope to operate as a controlled moment gyroscope. This allows the device 40 to provide a counteractive torque whenever an imbalanced movement is detected, in similar fashion to that described with respect to the device 10 above.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A neuroplasticity treatment device comprising:
a wearable body prosthesis;
at least one control moment gyroscopic attached to the prosthesis that produces a torque in the same axis but opposite to the direction of an imbalanced movement by a subject wearing the device.

2. The device of claim 1, wherein the wearable body prosthesis includes a harness that surrounds at least a portion of the torso of the wearer.

3. The device of claim 1, wherein the wearable body prosthesis includes at least one vertical mounting rail which allows the vertical position of the at least one control moment gyroscope to be adjusted with respect to the subject.

4. The device of claim 1, wherein the control moment gyroscope is attached to the prosthesis at a position which maximizes the torque relative to the center of balance of the subject.

5. The device of claim 4, wherein the control moment gyroscope is positioned near the second sacral vertebrae of the subject.

6. The device of claim 1 wherein the wearable body prosthesis includes a belt surrounding at least a portion of the waist and hips of the wearer.

7. The device of claim 1 wherein the device comprises a neuroplasticity treatment device for treating vertigo.

8. The device of claim 4 wherein the device comprises a plurality of CMGs spaced apart around and mounted upon the belt, said belt comprising a waist belt wearable garment, band, covering, attachment, appliance

9. A neuroplasticity treatment device comprising a wearable body prosthesis with control moment gyroscopic stabilization that produces a torque in the same axis but opposite to the direction of an imbalanced movement by a subject wearing the device.

10. A device, comprising:
a wearable body harness;
a gyroscope mounted to the harness, the gyroscope comprising:
a rotor assembly;
a first gimbal surrounding and operatively connected to the rotor assembly; and
a second gimbal surrounding and operatively connected to the first gimbal and the wearable body harness.

11. The device of claim 10, wherein the rotor assembly comprises:
a motor having a central shaft and a housing, said housing being rotatable about the central shaft, the central shaft having first and second ends fixedly connected to the first gimbal;
an annular rotor fixedly connected to the motor housing and rotatable about the central shaft with the motor housing; and
a plurality of energy storage devices mounted to the motor housing symmetrically about the central shaft and rotatable about the central shaft with the motor housing.

12. The device of claim 11, further comprising:
a first clutch connected between the first gimbal and the second gimbal, the first clutch operable to selectively lock the position of the first gimbal relative to the second gimbal; and
a controller operatively connected to the first clutch, said controller operable to operate the first clutch in a locked or free state.

13. The device of claim 12, further comprising:
a second clutch connected between said second gimbal and said wearable harness, said controller operable to operate the second clutch in locked or free state.

14. The device of claim 12, further comprising at least one balance sensor operably connected to said controller.

15. The device of claim 13, wherein the controller is configured to determine an imbalanced movement by a subject wearing the device and lock at least one of said first and second clutches in response to the imbalanced movement.

16. The device of claim 11, further comprising:
an upper mounting plate fixedly connected to said motor housing; and
a lower mounting plate fixedly connected to said motor housing;
wherein said upper and lower mounting plates are located on opposite sides of said annular rotor.

17. The device of claim 15,
wherein said rotor comprises a plurality of openings located symmetrically about said central shaft; and
wherein said plurality of energy storage devices pass through respective ones of said openings, said energy storage devices further mounted between said upper and lower mounting plates.

18. The device of claim 16, wherein said energy storage devices are cylindrical.

18. (canceled)

19. The device of claim 15, wherein said upper and lower mounting plates comprise a plurality of conductive members for electrically connecting the plurality of energy storage devices to the motor.

20. The device of claim 11, further comprising a switch operatively connected between the energy storage devices and the motor.
